(19) United States
(12) Patent Application Publication
(10) Pub. No.: US 2014/0059708 A1
(43) Pub. Date: Feb. 27, 2014

(54) APPARATUSES AND METHODS FOR PROTECTING PROGRAM FILE CONTENT USING DIGITAL RIGHTS MANAGEMENT (DRM)

(71) Applicants: Chi-Yang CHOU, Kao-hsiung (TW); Pei-Yen CHOU, Hsin-chu (TW); Yeu-Chung LIN, Chang-hua (TW)

(72) Inventors: Chi-Yang CHOU, Kao-hsiung (TW); Pei-Yen CHOU, Hsin-chu (TW); Yeu-Chung LIN, Chang-hua (TW)

(73) Assignee: CONDEL INTERNATIONAL TECHNOLOGIES INC., George Town (KY)

(21) Appl. No.: 13/592,693

(22) Filed: Aug. 23, 2012

(51) Int. Cl. G06F 21/24

(52) U.S. Cl. 726/30

(57) ABSTRACT

An electronic device for protecting program file content using Digital Rights Management (DRM) is provided with a DRM agent module, a plug-in, and a web browser module. The DRM agent module is configured to process DRM-protected content associated with a program file. The plug-in is configured to enable execution of the program file. The web browser module is installed with the DRM agent module, and is configured to activate the processing of the DRM-protected content of the DRM agent module to obtain the program file portion-by-portion, and use the plug-in to execute the program file with the obtained portions.

### BACKGROUND OF THE INVENTION

1. Field of the Invention

The invention generally relates to the field of content protection, and more particularly, to apparatuses and methods for protecting program file content using Digital Rights Management (DRM).

2. Description of the Related Art

In recent years, there has been an exponential growth in use of the Internet, coupled with the advances in technology, which has resulted in software programs, music, books, video games, and even full-length movies, becoming widely available in high-quality, easily reproducible and easily transmitted digital formats. Correspondingly, various content protection methods have been developed for stopping rampant piracy and unauthorized distribution, by controlling the access to the protected content. Generally, content protection methods may be divided into the two following groupings.

### Machine Unique Identification (UID) Binding

At first, a client device connects to a server for acquiring permission to download a program file which is the protected content referred to herein. For example, an on-line transaction for purchasing the rights to download a program file may be conducted, or a registration procedure may be performed for acquiring the permission. During the permission issuing process, the server may read the UID, such as the Media Access Control (MAC) address or license number of the used Operating System (OS), and embed the UID in a registration file for the particular client device, or embed the UID in the program file and re-compile the program file to make it specific to the client device. In the client device, when the program file is executed, it is first determined whether the UID of the client device matches the UID embedded in the registration file or the program file, and the execution of the program file may only continue, if the two UIDs match. Otherwise, the execution of the program file is aborted.

Alternatively, the server may burn the program file to a compact disc and assign an authentication Sequence Number (SN) with the compact disc. Later, when installing the program file from the compact disc to the client device, a registration procedure is initiated first to prompt the user to register online via the client device using the authentication SN. If the authentication SN is valid, the UID of the client device is read and embedded in a registration file which is delivered to the client device. The following operations regarding the execution of the program file in the client device are the same as those described above, and thus, will not be repeated.

This method, however, has several limitations/inconveniences. For instance, the source code of the program file is required for the embedding of the procedure code to enforce the UID check on the client device. Also, the source code of the program file must be developed so that disassembly is difficult to prevent the embedded procedure code from being removed. Additionally, a connection to the server is mandatory for downloading the program file. Lastly, the binding of the program file to one client device makes it impossible to move the program file to other client devices.

### Digital Rights Management (DRM)

DRM is an access control technology that is wildly used by hardware manufacturers, publishers, copyright holders, and individuals with the intent to limit the use of digital content and devices. In the case where the protected content is a program file or multimedia file, a corresponding software player is required to execute the protected content. For example, the Windows Media Player (WMP) is for executing the multimedia files with file extension “wmv” or “wma”, Java Virtual Machine (JVM) is for executing the program file with file extension “jar” or “class”, Adobe Flash Player is for executing the program file with file extension “swf”, and SilverLight Player is for executing the program file with file extension “xap, etc. Particularly, this kind of content is easy to be disassembled and replicated to any electronic device. Thus, the machine UID binding method would not be suitable here.

For content protection using DRM, the packager of a DRM server first packages and encrypts a program/multimedia file to generate DRM-protected content (also referred to as DRM content). As to this DRM-protected content, the Rights Management Module (RMM) of the DRM server further provides one or more corresponding Rights Objects (ROs) or licenses (both are to be referred to as ROs hereinafter) containing the encryption key which may be used later for decrypting the DRM-protected content. After that, the DRM-protected content and the RO(s) are delivered to an electronic device, and a DRM agent is installed to the software player in the electronic device. When the software player is required to access the DRM-protected content, the DRM agent is activated to determine whether the electronic device has a valid RO(s) for the DRM-protected content, and if not, the DRM agent connects to the DRM server to request to download a valid RO(s) corresponding to the DRM-protected content. Otherwise, if the electronic device has a valid RO(s), the DRM agent decrypts the DRM-protected content according to the encryption key in the RO(s), to obtain the program/multimedia file for legal usage.

It is noted that, the method has a huge drawback as it requires the source code of the software player for the DRM agent to be installed therein, or worse, it requires the source code of the OS and the configurations of the hardware resources for the DRM agent to be installed in the kernel of the OS. It is very likely that the company developing the software player or OS will not be willing to authorize the source code to a third party. Also, the cost for authorization may be high, and the complexity for installing the DRM agent may be large.

### BRIEF SUMMARY OF THE INVENTION

In one aspect of the invention, an electronic device for protecting program file content using DRM is provided. The electronic device comprises a DRM agent module, a plug-in, and a web browser module. The DRM agent module is configured to process DRM-protected content associated with a program file. The plug-in is configured to enable execution of the program file. The web browser module is installed with the DRM agent module, and is configured to activate the processing of the DRM-protected content of the DRM agent module to obtain the program file portion-by-portion, and use the plug-in to execute the program file with the obtained portions.

In another aspect of the invention, an electronic device for protecting program file content using DRM is provided. The electronic device comprises at least one RO, a plug-in, a DRM agent module, and a web browser module. The RO defines permissions for accessing DRM-protected content associated with a program file in the electronic device. The plug-in is configured to enable execution of the program file. The DRM agent module is configured to process the DRM-protected content with the RO. The web browser module is installed with the DRM agent module, and is configured to receive the DRM-protected content remotely from the Internet, activate the processing of the DRM-protected content of the DRM agent module to obtain the program file portion-by-portion, and use the plug-in to execute the program file with the obtained portions.

In yet another aspect of the invention, a method for protecting program file content using DRM in an electronic device is provided. The method comprises the steps of executing an executable file to launch a web browser installed with a DRM agent; processing, by the DRM agent, DRM-protected content associated with a program file to obtain the program file portion-by-portion, in response to an access attempt of the web browser to the DRM-protected content; and using, by the web browser, a plug-in to execute the program file with the obtained portions.

Other aspects and features of the invention will become apparent to those with ordinary skill in the art upon review of the following descriptions of specific embodiments of the electronic devices and methods for protecting program file content using DRM.

### BRIEF DESCRIPTION OF DRAWINGS

The invention can be more fully understood by reading the subsequent detailed description and examples with references made to the accompanying drawings, wherein:

FIG. 1 is a block diagram illustrating the software architecture of an electronic device according to an embodiment of the invention;

FIG. 2A is a schematic diagram illustrating the installation of a DRM agent in a web browser according to an embodiment of the invention;

FIG. 2B is a schematic diagram illustrating the installation of a DRM agent in a web browser according to another embodiment of the invention;

FIG. 3 is a block diagram illustrating the hardware architecture of an electronic device according to an embodiment of the invention;

FIG. 4 is a flowchart illustrating the method for protecting program file content using DRM in an electronic device according to an embodiment of the invention;

FIG. 5 is a schematic diagram illustrating an exemplary relation between a plurality of Flash files and multimedia files; and

FIGS. 6A and 6B show a flowchart illustrating the method for protecting program file content using DRM in an electronic device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

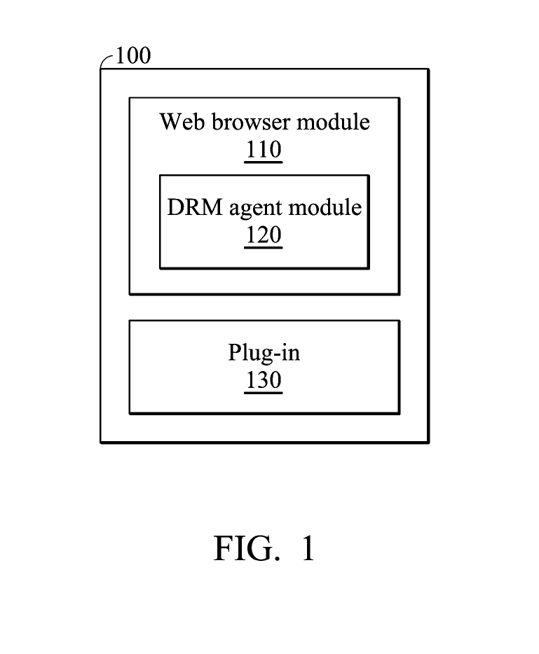

FIG. 1 is a block diagram illustrating the software architecture of an electronic device according to an embodiment of the invention. The electronic device may be a Personal Computer (PC), a laptop, a tablet PC, a smart phone, a multimedia player, a portable gaming device, or others. The software architecture 100 of the electronic device contains a web browser module 110, a DRM agent module 120, and a plug-in 130, wherein the DRM agent module 120 is installed in the web browser module 110. The web browser module 110 is a software application which provides the functionality of a web browser for retrieving, presenting, and traversing information resources either on a local webpage or from the Internet. Specifically, an information resource may be identified by a Uniform Resource Identifier (URI) and may be a web page, image, video, or other piece of content. Alternatively, the web browser may also be used to access information provided by locally maintained files. The web browser may be a Firefox, Google Chrome, Internet Explorer, Opera, Safari, or a web browser constructed by Web Kit or Web View SDK bearing similar functions of the aforementioned ones, etc.

The plug-in 130 may also be referred to as a browser extension or an add-on, which generally refers to a computer program for extending the functionality of a web browser. In this embodiment, the plug-in 130 enables the execution of certain program files for the web browser module 110. For example, the plug-in 130 may be a Flash plug-in for providing the functionality similar to the Adobe Flash Player, and the executable file corresponding to the Flash plug-in is the program files with the file extension of “swf”. The plug-in 130 may be a WMP plug-in for providing the functionality similar to the WMP, and the executable file corresponding to the WMP plug-in is the program files with the file extension of “wmv” or “wma”. The plug-in 130 may be a Java Virtual Machine (JVM) plug-in for providing the functionality similar to the JVM, and the executable file corresponding to the JVM plug-in is the program files with the file extension of “jar” or “class”. The plug-in 130 may be a SilverLight plug-in for providing the functionality similar to the SilverLight Player, and the executable file corresponding to the SilverLight plug-in is the program files with the file extension of “xap”. The plug-in 130 may be a Unity 3D plug-in for providing the functionality similar to the Unity 3D Game Engine, and the executable file corresponding to the Unity 3D plug-in is the program files with the file extension of “unity3d” or “js”.

Specifically, because the plug-in 130 is installed in the electronic device, the web browser module 110 may detect the existence of the plug-in 130, and when the web browser module 110 is required to access the program files associated with the plug-in 130, it may invoke the plug-in 130, i.e., using the plug-in 130, to execute the program files. Note that, during the execution of the program files, any input and output associated with the program files are made through the web browser module 110. Taking a Flash file as an example, during execution, if the Flash file requires a user to input a command, the command will be received by the web browser module 110 via the I/O device, such as a keyboard, a touch pad, or a touch panel, etc., and then forwarded to the plug-in 130. Likewise, if the Flash file requires other Flash files or multimedia files to be invoked, the requirement will be directed to be handled by the web browser module 110.

The DRM agent module 120 is a trusted entity in compliance with the DRM protocol, which is responsible for processing DRM-protected content according to one or more Rights Object (RO) corresponding to the DRM-protected content, which defines permissions for accessing the DRM-protected content in the electronic device. The processing includes enforcing permissions and constraints associated with the DRM-protected content, as well as controlling access to the DRM-protected content. Note that, the DRM agent module 120 is installed in the web browser module 110, and the access to any DRM-protected content must be made through the web browser module 110.

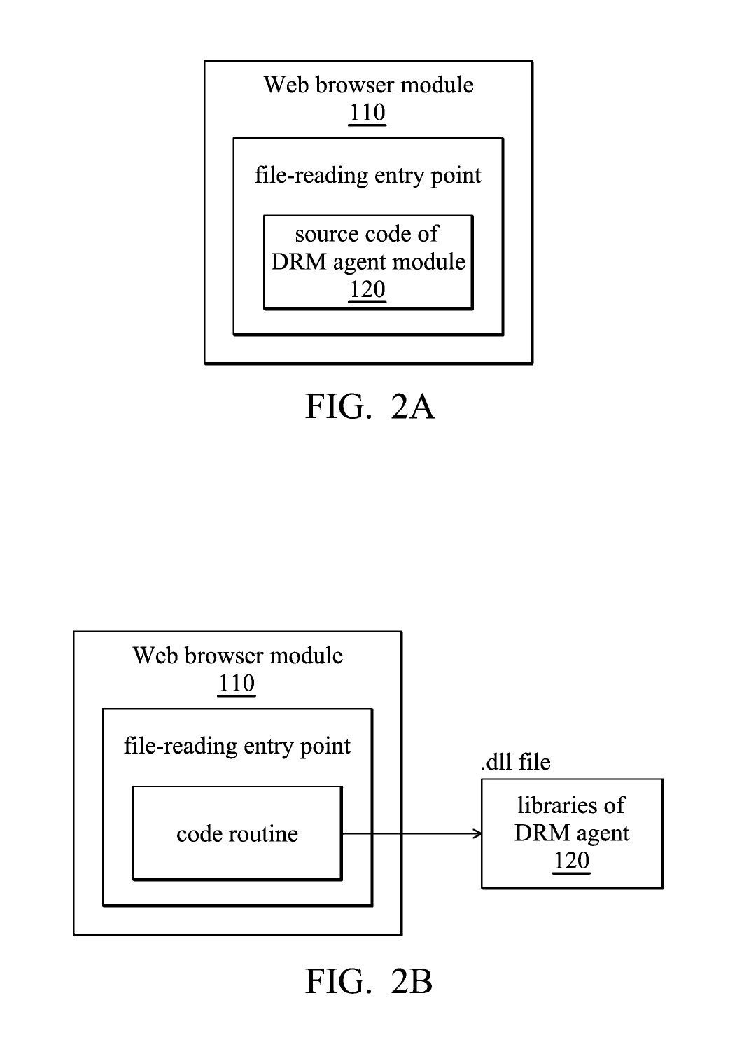

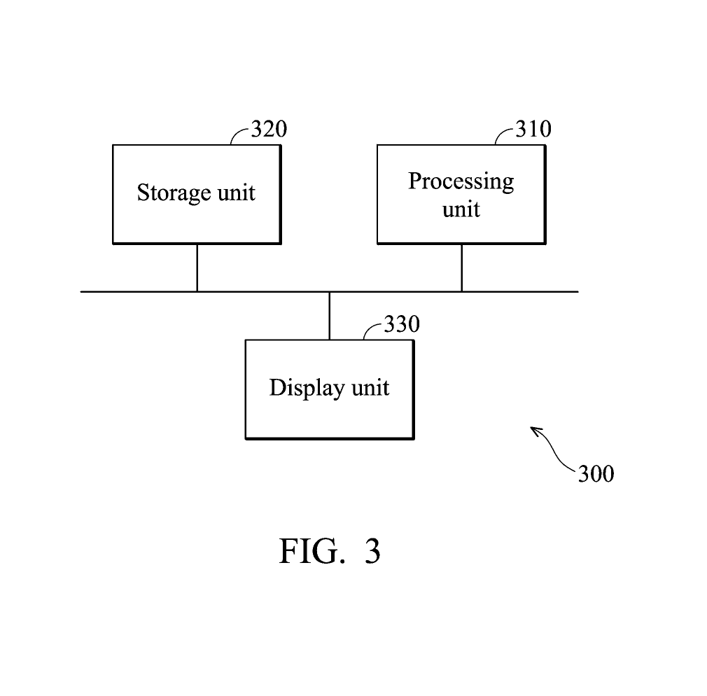

Specifically, the DRM agent module 120 is installed in the file-reading entry point of the web browser module 110, so that the processing of the DRM-protected content in the DRM agent module 120 is activated when the web browser module 110 is required to access DRM-protected content. Taking the Google Chrome web browser as a preferred example, the installation of the DRM agent module 120 in the file-reading entry point is particularly feasible since the Google Chrome web browser is an open-source web browser and the source code of the Google Chrome web browser is available and free for all, but the invention is not limited thereto. Please note that, the Google Chrome web browser installed with the DRM agent module 120 is different from the genuine Google Chrome web browser released to the public by Google™, and it may be referred to as a custom Google Chrome web browser made and used specific in this invention. In one embodiment, the installation of the DRM agent module 120 is performed by inserting the source code of the DRM agent module 120 in the file-reading entry point of the web browser module 110, as shown in FIG. 2A. In another embodiment, the installation of the DRM agent module 120 is performed by providing a code routine which was written using the Application Programming Interface (API) of the DRM agent module 120 for calling libraries of the DRM agent module 120, and inserting the code routine in the file-reading entry point of the web browser module 110, as shown in FIG. 2B.

To further clarify, the DRM-protected content refers to data packaged and encrypted by the packager in a DRM server (not shown), wherein the data may contain the program files associated with the plug-in 130, and the multimedia files, such as text files, image files, and video files, etc., associated with the program files. Also, the data may further contain a markup language file with the file extension of “html”, for the web browser to present visual effects or to call the program files and/or the multimedia files. A single RO may be generated by the RMM in the DRM server, for all of the program/multimedia/markup language files, or instead, a respective RO may be generated for each one of the program/multimedia/markup language files.

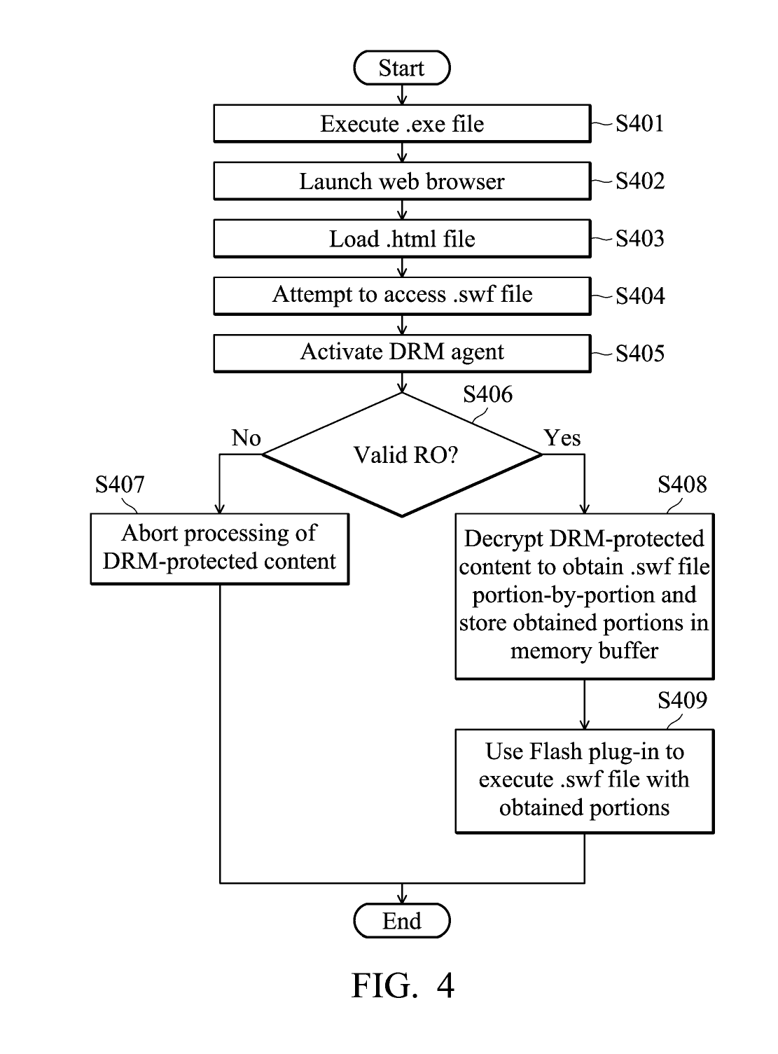

FIG. 3 is a block diagram illustrating the hardware architecture of an electronic device according to an embodiment of the invention. The hardware architecture 300 of the electronic device contains a processing unit 310, a storage unit 320, and a display unit 330. The processing unit 310 may be a general-purpose processor or a Micro-Control Unit (MCU) of the electronic device. The storage unit 320 may be a volatile memory, such as a Random Access Memory (RAM), a non-volatile memory, such as a flash memory, a hard disk, an optical disk, or any combination thereof, for storing the DRM-protected content and the program code or machine code of the web browser module 110, the DRM agent module 120, and the plug-in 130, which when loaded and executed by the processing unit 310, may perform the respective functions mentioned above. In addition, the storage unit 320 may also store the RO(s) corresponding to the DRM-protected content, wherein the DRM-protected content and the RO may be received from a DRM server (not shown) remotely located on the Internet, or may be read out from another storage medium (not shown) accessible when coupled to the electronic device. The display unit 330 may be a Cathode Ray Tube (CRT) screen, a Liquid Crystal Display (LCD), a plasma display panel, or others, for displaying a graphic user interface where the user may interact with a web browser presented therein. Although not shown, the hardware architecture 300 may comprise other functional units, such as a keyboard/keypad, a mouse, a touch pad, or a communication unit, such as an Ethernet card/chipset, a Wireless-Fidelity (WiFi) card/chipset, or a Baseband and Radio Frequency (RF) chipset for cellular communications.

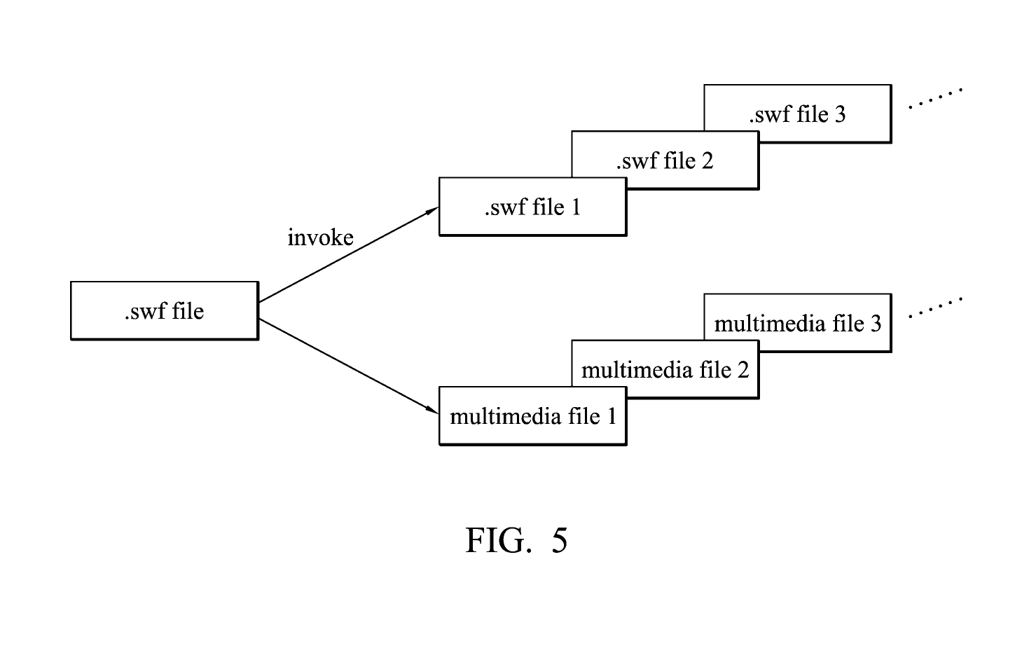

FIG. 4 is a flowchart illustrating the method for protecting program file content using DRM in an electronic device according to an embodiment of the invention. To begin, the electronic device executes an executable file (step S401). The executable file first launches a specific web browser, e.g., the custom Google Chrome web browser, which is installed with a DRM agent (step S402), and then indicates the web browser to load a markup language file which indicates the web browser to access the DRM-protected content (step S403). Note that, there may be multiple web browsers installed in the electronic device, and the executable file is provided to ensure that, even if the web browser is not the default web browser, the web browser, instead of the default web browser, such as the Internet Explorer for a Windows PC, is launched for carrying out the method proposed in the invention. In this embodiment, a Flash file, i.e., a program file with the file extension of “swf”, is packaged and encrypted by the packager of a DRM server, to generate the DRM-protected content, and a corresponding RO is generated by the RMM of the DRM server.

Next, the web browser attempts to access the DRM-protected content according to the markup language (step S404). In response to the access attempt to the DRM-protected content, the DRM agent installed in the web browser is activated (step S405). After being activated, the DRM agent first determines whether a valid RO corresponding to the DRM-protected content is located in the electronic device (step S406). That is, it is determined whether the electronic device has permission to access the DRM-protected content. If not, the DRM agent aborts the processing of the DRM-protected content (step S407). Otherwise, if the electronic device has a valid RO corresponding to the DRM-protected content, the DRM agent continues with the processing of the DRM-protected content.

In one embodiment, the DRM-protected content is downloaded and stored in the electronic device in advance, so that the DRM agent may process the DRM-protected content right after passing the RO check. In another embodiment, the DRM-protected content is stored remotely on the Internet and needs to be downloaded via the web browser before the DRM agent may start processing.

Specifically for the processing of the DRM-protected content, the DRM agent decrypts the DRM-protected content to obtain the Flash file portion-by-portion and stores the obtained portions in a memory buffer (step S408). Subsequently, the web browser uses a Flash plug-in which is installed in the electronic device, to execute the Flash file with the obtained portions (step S409), and the method ends.

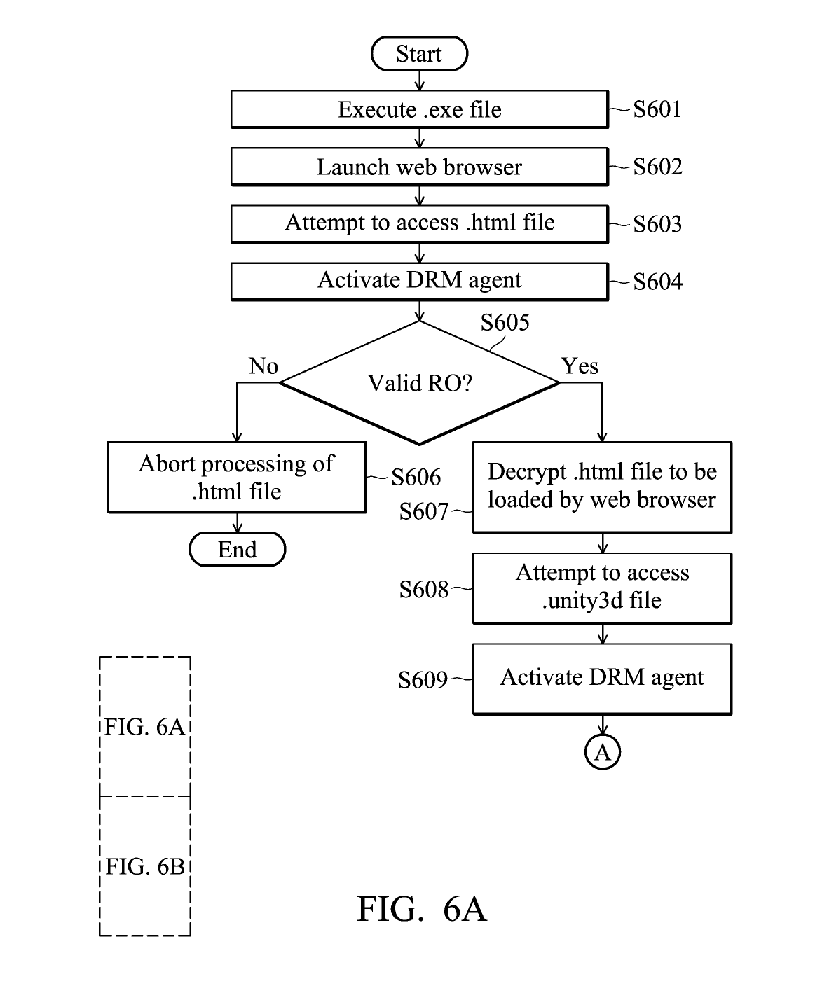

Note that, a Flash file may further invoke other Flash files and/or other multimedia files, as shown in FIG. 5, and all of these invoked files may be packaged and encrypted together, or each of these invoked files may be packaged and encrypted individually, to generate the DRM-protected content, and the steps S404-S409 may be repeated subsequent to step 5409 when any one of the files are invoked.

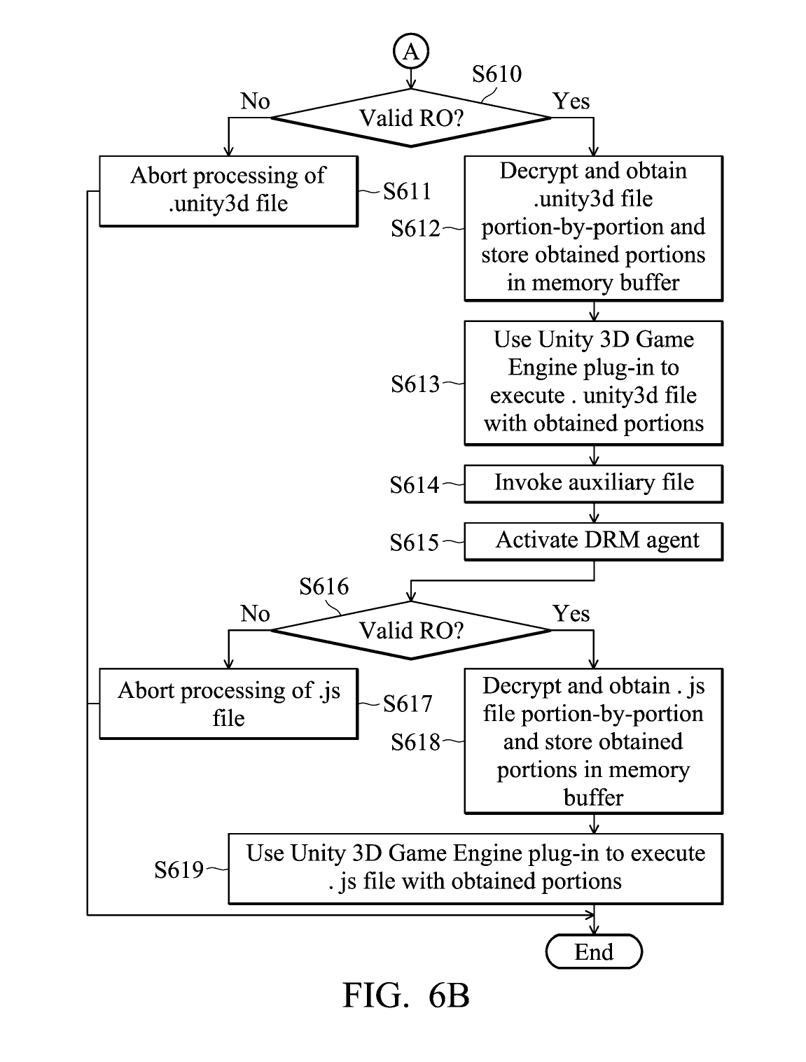

FIGS. 6A and 6B show a flowchart illustrating the method for protecting program file content using DRM in an electronic device according to another embodiment of the invention. Similar to FIG. 4, an executable file is executed to launch a specific web browser, and the web browser attempts to load a markup language file (steps S601-S603). However, in this embodiment, the markup language file, along with a Unity 3D file, i.e., a program file with the file extension of “unity3d”, and an auxiliary file of the Unity 3D file, i.e., a program file with the file extension of “js”, is packaged and encrypted to generate the DRM-protected content, and a respective RO is generated for each of the markup language file, the Unity 3D file, and the auxiliary file.

Next, in response to the access attempt to the markup language file which is DRM-protected, the DRM agent installed in the web browser is activated (step S604). After being activated, the DRM agent determines whether a valid RO corresponding to the markup language file is located in the electronic device (step S605). If not, the DRM agent aborts the processing of the markup language file (step S606). Otherwise, if the electronic device has a valid RO corresponding to the markup language file, the DRM agent continues with decrypting the markup language file to be loaded by the web browser (step S607). According to the markup language file, the web browser attempts to access the Unity 3D file (step S608).

In response to the access attempt to the Unity 3D file which is DRM-protected, the DRM agent installed in the web browser is activated (step S609). After being activated, the DRM agent first determines whether a valid RO corresponding to the Unity 3D file is located in the electronic device (step S610). If not, the DRM agent aborts the processing of the Unity 3D file (step S611). Otherwise, if the electronic device has a valid RO corresponding to the Unity 3D file, the DRM agent continues with the processing of the Unity 3D file.

Specifically for the processing of the Unity 3D file, the DRM agent decrypts and obtains the Unity 3D file portion-by-portion and stores the obtained portions in a memory buffer (step S612). Subsequently, the web browser uses a Unity 3D Game Engine plug-in which is installed in the electronic device, to execute the Unity 3D file with the obtained portions (step S613). Later, the auxiliary file is invoked during the execution of the Unity 3D file (step S614), and the DRM agent is activated for processing the auxiliary file which is also DRM-protected (step S615). Similar to steps S610-S613, a check on the RO corresponding to the auxiliary file is performed (step S616), and if not, the processing of the auxiliary file is aborted (step S617), and if so, the DRM agent decrypts and obtains the auxiliary file portion-by-portion and stores the obtained portions in a memory buffer for the web browser to use the Unity 3D Game Engine plug-in to execute the auxiliary file (step S618-S619).

Note that, there may be situations where multiple plug-ins are installed in the electronic device for enabling the execution of different types of program files, and the method may also be applied in such cases. For example, the embodiments in FIGS. 4, 6A, and 6B may be incorporated to illustrate that a markup language file indicates the web browser to access one or more Flash files and one or more Unity 3D files in sequence, or that a Flash file indicates the web browser to access one or more Unity 3D files.

It is to be understood that, although the web browser is used as an exemplary web browser in the embodiments of FIGS. 4, 6A, and 6B, another web browser may be used instead, such as a Firefox, Internet Explorer, Opera, Safari, or a web browser constructed by Web Kit or Web View SDK bearing similar functions of the aforementioned ones, etc., and the invention is not limited thereto. Although the Flash files and Unity 3D files are used as exemplary program files in the embodiments of FIGS. 4, 6A, and 6B, other program files may be used instead, such as WMP files, SilverLight files, or JVM files, etc., and the invention is not limited thereto.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. An electronic device for protecting program file content using Digital Rights Management (DRM), comprising:
a DRM agent module, processing DRM-protected content associated with a program file;
a plug-in, enabling execution of the program file; and
a web browser module, installed with the DRM agent module, activating the processing of the DRM-protected content of the DRM agent module to obtain the program file portion-by-portion, and using the plug-in to execute the program file with the obtained portions.

2. The electronic device of claim 1, wherein the DRM agent module is installed in a file-reading entry point of the web browser module, so that the processing of the DRM-protected content is activated when the web browser module is required to access the DRM-protected content.

3. The electronic device of claim 2, wherein the installation of the DRM agent module is performed by inserting source code of the DRM agent module in the file-reading entry point of the web browser module.

4. The electronic device of claim 2, wherein the installation of the DRM agent module is performed by providing a code routine which was written using the Application Programming Interface (API) of the DRM agent module for calling libraries of the DRM agent module, and inserting the code routine in the file-reading entry point of the web browser module.

5. The electronic device of claim 1, wherein the web browser module further receives the DRM-protected content remotely from the Internet for the DRM agent module to process.

6. The electronic device of claim 1, wherein the DRM-protected content is located in the electronic device or in a storage medium accessible when coupled to the electronic device, for the DRM agent module to process.

7. The electronic device of claim 1, wherein the plug-in is for a Flash, SilverLight, Java Virtual Machine (JVM), or Unity 3D Game Engine associated program file execution, and a file extension of the program file is “swf”, “xap”, “jar” or “class”, or “unity3d” or “js”, respectively.

8. An electronic device for protecting program file content using Digital Rights Management (DRM), comprising:
at least one Rights Object (RO), defining permissions for accessing DRM-protected content associated with a program file in the electronic device;
a plug-in, enabling execution of the program file;
a DRM agent module, processing the DRM-protected content with the RO; and
a web browser module, installed with the DRM agent module, receiving the DRM-protected content remotely from the Internet, activating the processing of the DRM-protected content of the DRM agent module to obtain the program file portion-by-portion, and using the plug-in to execute the program file with the obtained portions.

9. The electronic device of claim 8, wherein the DRM agent module is installed in a file-reading entry point of the web browser module, so that the processing of the DRM-protected content is activated when the web browser module is required to access the DRM-protected content.

10. The electronic device of claim 9, wherein the installation of the DRM agent module is performed by inserting source code of the DRM agent module in the file-reading entry point of the web browser module.

11. The electronic device of claim 9, wherein the installation of the DRM agent module is performed by providing a code routine which was written using the Application Programming Interface (API) of the DRM agent module for calling libraries of the DRM agent module, and inserting the code routine in the file-reading entry point of the web browser module.

12. The electronic device of claim 8, wherein the plug-in is for a Flash, SilverLight, Java Virtual Machine (JVM), or Unity 3D Game Engine associated program file execution, and a file extension of the program file is “swf”, “xap”, “jar” or “class”, or “unity3d” or “js”, respectively.

13. A method for protecting program file content using Digital Rights Management (DRM) in an electronic device, comprising:
executing an executable file to launch a web browser installed with a DRM agent;
processing, by the DRM agent, DRM-protected content associated with a program file to obtain the program file portion-by-portion, in response to an access attempt of the web browser to the DRM-protected content; and
using, by the web browser, a plug-in to execute the program file with the obtained portions.

14. The method of claim 13, further comprising:
loading, by the web browser, a markup language file indicating the access attempt to the DRM-protected content;

15. The method of claim 13, further comprising:
loading, by the web browser, a DRM-protected markup language file; and
processing, by the DRM agent, the DRM-protected markup language file to obtain the markup language file which indicates the access attempt to the DRM-protected content.

16. The method of claim 13, wherein the processing step is performed according to one or more Rights Objects (ROs) defining permissions for accessing the DRM-protected content in the electronic device.

17. The method of claim 13, further comprises:
receiving, by the web browser, the DRM-protected content remotely from the Internet for the DRM agent to process.

18. The method of claim 13, wherein the DRM-protected content is located in the electronic device or in a storage medium accessible when coupled to the electronic device, for the DRM agent to process.
